(19) United States
(12) Patent Application Publication
(10) Pub. No.: US 2024/0246044 A1
(43) Pub. Date: Jul. 25, 2024

(54) HIGH SHEAR MIXING DEVICE

(71) Applicants: LG Energy Solution, Ltd., Seoul (KR); LG ELECTRONICS INC., Seoul (KR)

(72) Inventors: Taegon Kim, Daejeon (KR); Sung Sik Kim, Gyeonggi-do (KR); Jae Seong Park, Gyeonggi-do (KR); Jeonggil Kim, Daejeon (KR); Myeongsoo Kim, Daejeon (KR); Hee Jeong Nam, Gyeonggi-do (KR)

(21) Appl. No.: 18/578,246

(22) PCT Filed: Jan. 26, 2023
(86) PCT No.: PCT/KR2023/001161

§ 371 Date: Jan. 10, 2024

(30) Foreign Application Priority Data
Jan. 28, 2022 (KR) 10-2022-0013049

(51) Int. Cl. B01F 27/922; B01F 27/1143; B01F 27/1145; B01F 35/32; B01F 101/00

(52) U.S. Cl. CPC B01F 27/922; B01F 27/1143; B01F 27/11451; B01F 35/3231; B01F 2101/2805; B01F 2215/0427

(57) ABSTRACT

A high shear mixing device is provided. The high shear mixing device comprises a first screw kneader and a second screw kneader; a first rotation driving mechanism configured to rotate the first screw kneader and a second rotation driving mechanism configured to rotate the second screw kneader; a revolution driving mechanism including the first rotation driving mechanism and the second rotation driving mechanism rotatably installed therein; a driving mechanism body including the revolution driving mechanism installed therein; and a mixing tank. Each of the first screw kneader and the second screw kneader comprises a shaft having one end connected to the rotation driving mechanism; and three or more blades having one end fixed to the shaft and having a helically curved body along the longitudinal direction of the shaft, and the first and second screw kneaders rotate in opposite directions with their blades overlapping each other.

### CROSS-REFERENCE TO RELATED APPLICATION

This application is a US national phase of international application No. PCT/KR2023/001161 filed on Jan. 26, 2023, and claims priority to Korean Patent Application No. 10-2022-0013049, filed on Jan. 28, 2022, the disclosures of which are hereby incorporated by reference in their entirety.

### FIELD

The present disclosure relates to a high shear mixing device, particularly, a high shear mixing device used for preparing a dry electrode for a secondary battery.

### BACKGROUND

The stirring device is used to finely mix various paste manufacturing facilities and chemical raw materials, such as inks, pigments, paints, cosmetics, pharmaceuticals and paints, various coatings, abrasives, ceramics or metal powder or various electronic materials (PZT, dielectric, MLCC, ferrite, display materials). As the stirring device, in particular, as equipment for stirring high-viscosity substances, a planetary mixer that stirs high-viscosity substances in a container using a blade and a rotor is widely used.

The planetary mixer as described above is also used to prepare an electrode for a secondary battery. That is, along with the expansion of the use or the development of the secondary battery, improvements in low resistance, high capacity, mechanical properties and productivity of the electrode are continuously required, and thus the need for high shear mixing of the mixture to prepare the electrode is also increasing.

Specifically, recently, a technology for preparing a dry electrode film by mixing an active material, a binder, and an electrically conductive material without a liquid medium such as a solvent or dispersion medium, and then passing the powder mixture through a rolling roll, is being actively developed, and high shear mixing has been applied to this preparation of the electrode.

That is, in the above method, a binder called “fiberizable binder” or “fiber-forming binder” is used. If high shear mixing is applied to the mixture containing the binder, the binder is micro-fiberized to adhere the active material and the electrically conductive material.

However, in this high shear mixing process, the fiberizable polymer becomes chewing gum-like state, and a high load is applied to the high shear mixing device, and thus the high shear mixing device is often damaged. Meanwhile, if the shear force is lowered to prevent damage to the equipment as described above, fiberization of the fiberizable polymer is not performed well. Accordingly, due to these problems, it is very difficult to constitute the high shear mixing device as a mass-production equipment for preparing a dry electrode for a secondary battery.

### RELATED ART

Korean Laid-open Patent Publication No. 10-2011-0117902

### SUMMARY

The present disclosure has been devised to solve the above problems in the prior art, and it is an object of the present disclosure to provide a high shear mixing device capable of efficiently mixing materials without overload when mixing materials by high shear force.

In particular, it is an object of the present disclosure to provide a high shear mixing device capable of efficiently micro-fiberizing the polymer without overload during high shear mixing of a mixture for preparing a dry electrode comprising a fiberizable polymer as a binder.

In order to achieve the above object, the present disclosure provides a high shear mixing device comprising:
a first screw kneader and a second screw kneader;
a first rotation driving mechanism configured to rotate the first screw kneader, and a second rotation driving mechanism configured to rotate the second screw kneader;
a revolution driving mechanism including the first rotation driving mechanism and the second rotation driving mechanism rotatably installed therein;
a driving mechanism body including the revolution driving mechanism installed therein; and
a mixing tank,
wherein each of the first screw kneader and the second screw kneader comprises a shaft having one end respectively connected to the first rotation driving mechanism and the second rotation driving mechanism; and three or more blades having one end fixed to the shaft and having a helically curved body along the longitudinal direction of the shaft, and
wherein the first and second screw kneaders rotate in opposite directions with their blades overlapping each other.

In one embodiment of the present disclosure, the high shear mixing device has a feature that the first and second screw kneaders rotate by the first and second rotation driving mechanisms and revolve by the revolution driving mechanism at the same time.

In one embodiment of the present disclosure, all of the blades provided in the first screw kneader and the second screw kneader may be open-type blades comprising a through hole formed in a center portion except an outer periphery of a surface in a rotation direction.

In one embodiment of the present disclosure, all of the blades provided in the first screw kneader and the second screw kneader may be closed-type blades of which a surface in a rotation direction is closed without a through hole.

In one embodiment of the present disclosure, all of the blades provided in the first screw kneader may be open-type blades comprising a through hole formed in a center portion except an outer periphery of a surface in a rotation direction, and
all of the blades provided in the second screw kneader may be closed-type blades of which a surface in a rotation direction is closed without a through hole.

In one embodiment of the present disclosure, each of the first screw kneader and the second screw kneader may have three blades.

In one embodiment of the present disclosure, one of the three blades provided in each of the first screw kneader and the second screw kneader may be an open-type blade comprising a through hole formed in a center portion except an outer periphery of a surface in a rotation direction, and the other two blades may all be closed-type blades of which a surface in a rotation direction is closed without a through hole.

In one embodiment of the present disclosure, each of the through holes formed in the blades may be formed to extend to an outer peripheral surface of the shaft.

In one embodiment of the present disclosure, in the screw kneader comprising the open-type blades, the shaft between the through holes may be removed such that all of the through holes formed in the blades communicate with each other.

In one embodiment of the present disclosure, distal ends in a rotation direction of the blades provided in one of the first screw kneader and the second screw kneader may rotate while maintaining a separation distance of 1 mm to 10 mm from the other screw kneader.

In one embodiment of the present disclosure, the high shear mixing device is used for high shear mixing of a mixture for preparing a dry electrode containing a fiberizable polymer as a binder, thereby micro-fiberizing the fiberizable polymer.

The high shear mixing device of the present disclosure provides an effect capable of efficiently mixing materials without overload when mixing materials by high shear force. In addition, since damage to the device is minimized by this effect, it has a feature that it is possible to configure the device in a large capacity.

In particular, the high shear mixing device of the present disclosure provides an effect of efficiently micro-fiberizing the polymer without overload during high shear mixing of a mixture for preparing a dry electrode containing a fiberizable polymer as a binder.

### BRIEF DESCRIPTION OF DRAWINGS

FIG. 1 is a perspective view showing one embodiment of a high shear mixing device of the present disclosure.

FIG. 2 is a perspective view showing one embodiment of a screw kneader provided in the high shear mixing device of the present disclosure.

FIG. 3 is a perspective view showing another embodiment of a screw kneader provided in the high shear mixing device of the present disclosure.

FIG. 4 is a perspective view showing another embodiment of a screw kneader provided in the high shear mixing device of the present disclosure.

FIG. 5 is a perspective view showing another embodiment of a screw kneader provided in the high shear mixing device of the present disclosure.

### DETAILED DESCRIPTION

Hereinafter, examples of the present disclosure will be described in detail with reference to the accompanying drawings so that those of ordinary skill in the art can easily carry out the present disclosure. However, the present disclosure may be embodied in many different forms and is not limited to the examples described herein. Throughout the specification, like reference numerals are assigned to similar parts.

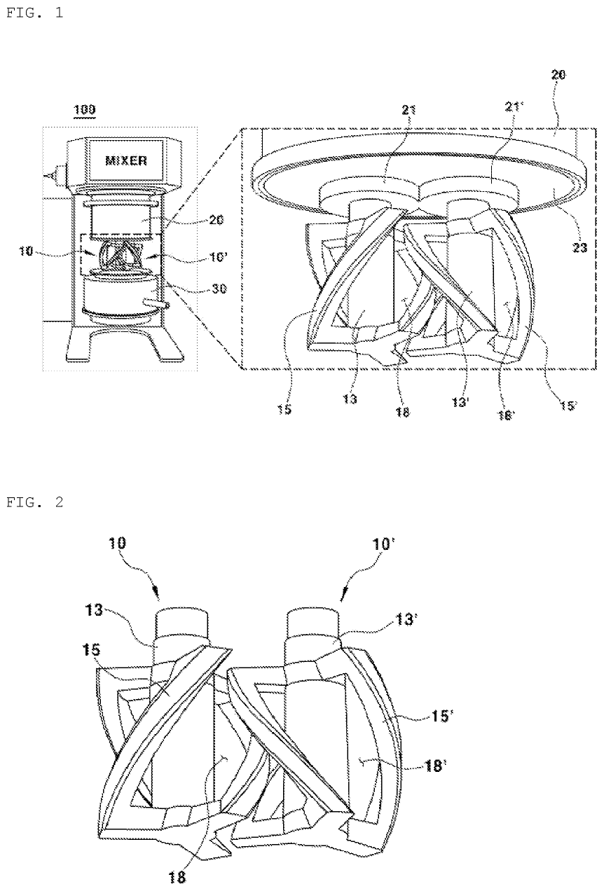

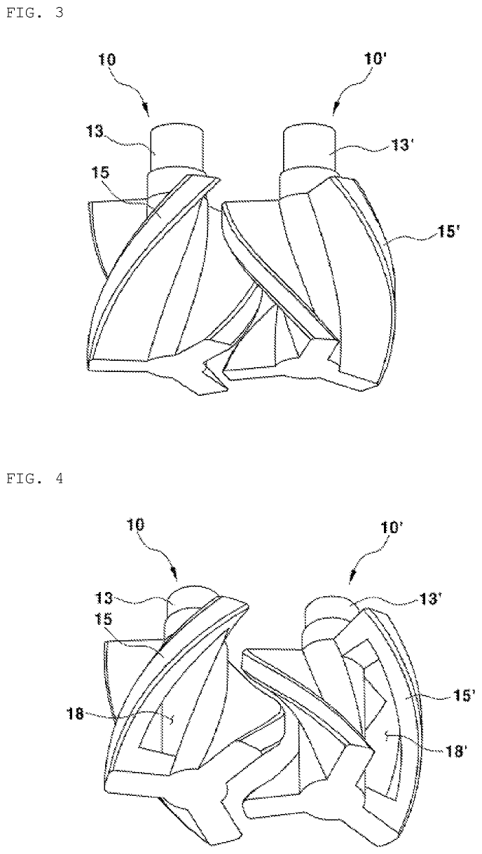

FIG. 1 is a perspective view showing one embodiment of a high shear mixing device 100 of the present disclosure, and FIGS. 2 to 5 are perspective views illustrating another embodiment of a screw kneader provided in the high shear mixing device 100 of the present disclosure.

The high shear mixing device 100 of the present disclosure, as shown in FIG. 1, comprises
the first screw kneader 10 and the second screw kneader 10′; the first rotation driving mechanism 21 configured to rotate the first screw kneader and the second rotation driving mechanism 21′ configured to rotate the second screw kneader; the revolution driving mechanism 23 in which the first rotation driving mechanism 21 and the second rotation driving mechanism 21′ are rotatably installed; the driving mechanism body 20 in which the revolution driving mechanism 23 is installed; and the mixing tank 30,
wherein each of the first screw kneader 10 and the second screw kneader 10′ comprises shafts 13 and 13′ having one end connected to the rotation driving mechanisms 20 and 21′; and three or more blades 15 and 15′ having one end fixed to the shaft and having a helically curved body along the longitudinal direction of the shaft, and
wherein the first and second screw kneaders 10 and 10′ rotate in opposite directions with their blades 15 and 15′ overlapping each other. When the screw kneaders rotate and engage with each other, they are characterized by revolving in the opposite direction to the direction in which the mixtures are discharged.

The high shear mixing device 100 of the present disclosure may be particularly preferably used for preparing a dry electrode for a secondary battery. That is, when preparing a dry electrode for a secondary battery, the high shear mixing device produces a freestanding electrode through a process of high shear mixing the mixture comprising an active material, an electrically conductive material, and a fiberizable binder such as PTFE as a binder to fiberize the binder, and rolling the prepared mixture. During this high shear mixing process, the fiberizable polymer becomes chewing gum-like state and a high load is applied to the high shear mixing device, which often damages the equipment. On the other hand, if the shear force is lowered to prevent damage to the equipment as described above, fiberization of the fiberizable polymer is not performed well. Therefore, due to these problems, it is very difficult to constitute a high shear mixing device as a large-capacity mass-production equipment for preparing a dry electrode for a secondary battery.

However, if the high shear mixing device of the present disclosure is used, while the dispersibility of the mixture is greatly improved and the micro-fiberization of the fiberizable polymer is effectively achieved, there is no heavy load on the device. Therefore, the high shear mixing device of the present disclosure can be preferably used in high shear mixing for preparing a dry electrode for a secondary battery, and makes it possible to constitute a large-capacity mass-production equipment.

If the high shear mixing device of the present disclosure is used, while continuously applying a high-shear force of 10 to 500 N·m to the mixture comprising an active material, an electrically conductive material, and a fiberizable binder such as PTFE as a binder, it is possible to prepare the mixture for a freestanding electrode having good quality without damage to the equipment. In addition, in the case of rolling such mixture, a free-standing electrode having excellent tensile strength is prepared, and when a battery is constituted by such an electrode, the lifetime of the battery is greatly improved.

In one embodiment of the present disclosure, one end of the body of the blades 15 and 15′ is coupled to the shaft in a spiral shape in the longitudinal direction, and accordingly, the body surface in the rotational direction may have a shape that is spirally bent along the longitudinal direction of the shaft.

In the present disclosure, the body of the blades 15 and 15′ may have a shape in which the body having a shape of a circular plate with one end cut off, an oval plate with one end cut off or a polygonal plate is spirally bent along the longitudinal direction of the shafts 13 and 13′. In this case, the body may also have a shape in which the exemplified shape is partially modified to be advantageous for high shear mixing. If the body has the polygonal shape, it may be a polygonal shape such as a triangle, a quadrangle, a pentagon, and a hexagon, and is not particularly limited. However, a rectangular shape may be more preferably used.

In one embodiment of the present disclosure, the high shear mixing device 100 has a feature that the screw kneaders 10 and 10′ rotate by the rotation driving mechanisms 21 and revolve by the revolution driving mechanism 23. In addition, when the screw kneaders rotate and engage with each other, they are characterized by revolving in the opposite direction to the direction in which the mixtures are discharged. As described above, if the screw kneaders rotate and revolve at the same time, the mixture is more uniformly mixed and high shear mixing can be performed more efficiently, which is preferable.

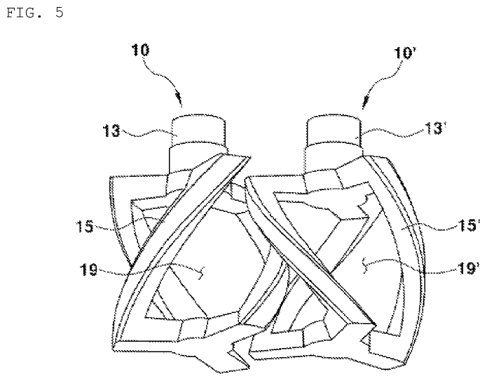

In one embodiment of the present disclosure, all of the blades 15 and 15′ provided in the first screw kneader 10 and the second screw kneader 10′ may be open-type blades in which through holes 18, 18′, 19, and 19′ are formed in the center portion except for the outer periphery of the surface in the rotation direction, as shown in FIGS. 2 and 5. In this case, the outer peripheral portion adjacent to the shaft among the outer peripheral portion may be removed by extending the through holes 18 and 18′.

The through holes 18 and 18′ formed in the blades 15 and 15′ of the first screw kneader 10 and the second screw kneader 10′ shown in FIG. 2 represent shapes in which the through-holes are independently formed in each blade. That is, the through holes 18 and 18′ represent shapes in which a through hole is formed in the center portion except the outer periphery of the surface of the blade in the rotation direction, and in particular, the shape shown in FIG. 2 represents a shape in which the through hole extends to the outer peripheral surface of the shaft.

In one embodiment of the present disclosure, the area of the through holes 18 and 18′ may be formed to be 40 to 80%, more preferably 50 to 70% relative to the total area of the rotation direction surface of the blade body. If the through hole is formed within the above range, it is preferable because the mixture is effectively mixed without applying a high load to the device. In particular, within the above range, micro-fiberization of the fiberizable polymer can also be effectively achieved.

The first screw kneader 10 and the second screw kneader 10′ shown in FIG. 5 have shapes in which the shaft between the through holes is removed so that the through holes 19 and 19′ formed in their blades 15 and 15′ are all communicated.

In one embodiment of the present disclosure, all of the blades provided in the first screw kneader 10 and the second screw kneader 10′ may be closed-type blades of which the surface in the rotation direction is closed without a through hole, as shown in FIG. 3.

In one embodiment of the present disclosure, all of the blades provided in the first screw kneader 10 may be open-type blades in which through holes 18, 18′, 19, and 19′ are formed in the center portion except the outer periphery of the surface in the rotation direction, as shown in FIGS. 2 and 5, and all of the blades provided in the second screw kneader 10′ may be closed-type blades of which the surface in the rotation direction is closed without a through hole, as shown in FIG. 3.

In one embodiment of the present disclosure, the first screw kneader 10 and the second screw kneader 10′ may be provided with three blades, respectively.

In one embodiment of the present disclosure, any one blade of the three blades provided in each of the first screw kneader 10 and the second screw kneader 10′ may be open-type blades in which through holes 18 and 18′ are formed in the center portion except the outer periphery of the surface in the rotation direction, and the other two blades may all be closed-type blades of which the surface in the rotation direction is closed without a through hole, as shown in FIG. 4. If the first screw kneader (10) and the second screw kneader (10′) of this shape are comprised, the dispersibility of the mixture is greatly improved, and fiberization of a fiberizable polymer such as PTFE is effectively achieved. In addition, during the fiberization process of the fiberizable polymer such as PTFE, a large load is not applied to the device. Therefore, the high shear mixing device of the present disclosure can be preferably used in high shear mixing for preparing a dry electrode for a secondary battery, and makes it possible to constitute a large-capacity mass-production equipment.

In particular, if a dry freestanding electrode is prepared by high shear mixing the mixture comprising an active material, an electrically conductive material, and a fiberizable binder such as PTFE as a binder and rolling such mixture, the tensile strength of the freestanding electrode is greatly improved, and this dry freestanding electrode provides the effect of greatly improving the lifetime of the secondary battery.

In one embodiment of the present disclosure, the through holes 18 and 18′ of the blades may be formed to extend to the outer peripheral surface of the shaft, as shown in FIG. 4.

In one embodiment of the present disclosure, the screw kneaders 10 and 10′ comprising the open-type blades may have a shape in which a shaft between the through holes is removed so that the through holes 19 and 19′ formed in the blades are all communicated.

In one embodiment of the present disclosure, it may be preferable that the distal ends in the rotation direction of the blades provided in one of the first screw kneader and the second screw kneader rotate while maintaining a separation distance of 1 mm to 10 mm, preferably 1 mm to 5 mm, more preferably 1 mm to 3 mm from the other screw kneader. When having the above separation distance, fiberization of a fiberizable polymer such as PTFE is effectively achieved, and the high shear mixing device is not subjected to a large load that may damage the device, and thus it is possible to efficiently prepare a freestanding electrode of good quality.

In one embodiment of the present disclosure, it is more preferable that the rotational speed of the first screw kneader and the second screw kneader is 10 rpm to 500 rpm, preferably 10 rpm to 300 rpm, more preferably 10 rpm to 150 rpm. If high shear mixing is performed at the above speed, fiberization of a fiberizable polymer such as PTFE is effectively achieved, the high shear mixing device is not subjected to a large load that may damage the device, and thus it is possible to efficiently prepare a freestanding electrode of good quality. In addition, revolution speed may be 5 rpm to 100 rpm, preferably 10 rpm to 50 rpm, more preferably 10 rpm to 30 rpm.

Hereinafter, the present disclosure will be described in detail by way of example in order to specifically explain the present disclosure. However, the examples according to the present disclosure may be modified in various other forms, and the scope of the present disclosure should not be construed as being limited to the examples described in detail below. The examples of the present disclosure are provided to more completely explain the present disclosure to those of ordinary skill in the art.

### Example 1: Preparation of Freestanding Electrodes by High Shear Mixing Device

95.5% by weight or 97% by weight of NCM powder, which is particles of positive electrode active material with an average particle diameter of 10 μm (Product name: GL80, LG Chem company), 1.5% by weight of Li250 (Denka company) as an electrically conductive material and PTFE as binder (1.5% by weight or 3% by weight) was mixed to prepare a mixture for a freestanding electrode.

The high shear mixing device of the present disclosure was constituted as shown in Table 1 below, and high shear mixing was performed for 2 minutes by applying a shear force of 100 N·m to the mixture at 90° C. at the rotation of 30 rpm and revolution of 15 rpm.

Next, the secondary mixture in the form of dough prepared above was milled at 100° C. with a two roll mill (MR-3, Inoue company) to prepare a free-standing film having a thickness of 200 μm.

Thereafter, the free-standing film was placed on one side of a Primer Coated Aluminum Foil (Manufactured by Dongwon Systems company) current collector having a thickness of 20 μm, and bonded through a lamination roll maintained at 120° C. to prepare a positive electrode.

TABLE 1

| | Constitution of high shear mixing device | | | | | | |
|---|---|---|---|---|---|---|---|
| | | | | Arrangement | | | |
| | | | | of first | Rotation | | Binder |
| | | | | and second | of screw | Mixing | content |
| | Shape of screw kneader | | | screw blade | kneader | volume | (wt %) |
| Example 1 | first | first blade is open- | shape | overlap | revolution + | 1.5 L | 1.5 |
| | screw | type (through hole | of | | rotation | | |
| | kneader | formation) and second | FIG. 4 | | | | |
| | | and third blades are | | | | | |
| | | closed-type | | | | | |
| | second | first blade is open- | | | | | |
| | screw | type (through hole | | | | | |
| | kneader | formation) and second | | | | | |
| | | and third blades are | | | | | |
| | | closed-type | | | | | |
| Example 2 | first | first blade is open- | shape | overlap | revolution + | 1.5 L | 3.0 |
| | screw | type (through hole | of | | rotation | | |
| | kneader | formation) and second | FIG. 4 | | | | |
| | | and third blades are | | | | | |
| | | closed-type | | | | | |
| | second | first blade is open- | | | | | |
| | screw | type (through hole | | | | | |
| | kneader | formation) and second | | | | | |
| | | and third blades are | | | | | |
| | | closed-type | | | | | |
| Example 3 | first | first, second and | | overlap | revolution + | 1.5 L | 3.0 |
| | screw | third blades are all | | | rotation | | |
| | kneader | open-type (through | | | | | |
| | | hole formation) | | | | | |
| | second | first, second and | | | | | |
| | screw | third blades are all | | | | | |
| | kneader | closed-type | | | | | |
| Example 4 | first | first, second and | shape | overlap | revolution + | 1.5 L | 3.0 |
| | screw | third blades are all | of | | rotation | | |
| | kneader | open-type (through | FIG. 5 | | | | |
| | | hole formation) | | | | | |
| | second | first, second and | | | | | |
| | screw | third blades are all | | | | | |
| | kneader | open-type (through | | | | | |
| | | hole formation) | | | | | |
| Example 5 | first | first, second and | shape | overlap | revolution + | 1.5 L | 3.0 |
| | screw | third blades are all | of | | rotation | | |
| | kneader | closed-type | FIG. 3 | | | | |
| | second | first, second and | | | | | |
| | screw | third blades are all | | | | | |
| | kneader | closed-type | | | | | |
| Comparative | first | first blade is open- | shape | overlap | rotation | 0.5 L | 1.5 |
| Example 1 | screw | type (through hole | of | | | | |
| | kneader | formation) and second | FIG. 4 | | | | |
| | | and third blades are | | | | | |
| | | closed-type | | | | | |
| | second | first blade is open- | | | | | |
| | screw | type (through hole | | | | | |
| | kneader | formation) and second | | | | | |
| | | and third blades are | | | | | |
| | | closed-type | | | | | |
| Comparative | first | first blade is open- | shape | overlap | rotation | 0.5 L | 3.0 |
| Example 2 | screw | type (through hole | of | | | | |
| | kneader | formation) and second | FIG. 4 | | | | |
| | | and third blades are | | | | | |
| | | closed-type | | | | | |
| | second | first blade is open- | | | | | |
| | screw | type (through hole | | | | | |
| | kneader | formation) and second | | | | | |
| | | and third blades are | | | | | |
| | | closed-type | | | | | |
| Comparative | first | first, second and | shape | overlap | rotation | 0.5 L | 3.0 |
| Example 3 | screw | third blades are all | of | | | | |
| | kneader | open-type (through | FIG. 5 | | | | |
| | | hole formation) | | | | | |
| | second | first, second and | | | | | |
| | screw | third blades are all | | | | | |
| | kneader | lopen-type (through | | | | | |
| | | hole formation) | | | | | |
| Comparative | first | first, second and | shape | overlap | rotation | 0.5 L | 3.0 |
| Example 4 | screw | third blades are all | of | | | | |
| | kneader | closed-type | FIG. 3 | | | | |
| | second | first, second and | | | | | |
| | screw | third blades are all | | | | | |
| | kneader | closed-type | | | | | |
| Comparative | first | first, second and | shape | non-overlap | rotation | 0.1 L | 1.5 |
| Example 5 | screw | third blades are all | of | | | | |
| | kneader | closed-type | FIG. 3 | | | | |
| | second | first, second and | | | | | |
| | screw | third blades are all | | | | | |
| | kneader | closed-type | | | | | |
| Comparative | first | first, second and | shape | non-overlap | rotation | 0.1 L | 3.0 |
| Example 6 | screw | third blades are all | of | | | | |
| | kneader | closed-type | FIG. 3 | | | | |
| | second | first, second and | | | | | |
| | screw | third blades are all | | | | | |
| | kneader | closed-type | | | | | |

| | | | | |
|---|---|---|---|---|
| Comparative | Lab. Blender | rotation | 0.1 L | 3.0 |
| Example 7 | | | | |

(Note)
Overlap: The distal ends in the rotation direction of the blades provided on one of the first screw kneader and the second screw kneader maintain a separation distance of 3 mm from the other screw kneader.

### Experimental Example 1: Measurement of Tensile Strength of Freestanding Electrode

The tensile strength of the freestanding electrodes prepared in Examples 1 to 5 and Comparative Examples 1 to 7 was measured at a condition of 50 mm/min by a 180 degrees peel measurement method using UTM equipment of LLOYD company. At the time of the measurement, the maximum value of the force applied up to the point in time when the film did not break was evaluated as the strength of the free-standing film, and the measurement results are shown in Table 2 below.

TABLE 2

| | | | | | | Compar- | Compar- | Compar- | Compar- | Compar- | Compar- | Compar- |
|---|---|---|---|---|---|---|---|---|---|---|---|---|
| | | | | | | ative | ative | ative | ative | ative | ative | ative |
| | Example | Example | Example | Example | Example | Example | Example | Example | Example | Example | Example | Example |
| | 1 | 2 | 3 | 4 | 5 | 1 | 2 | 3 | 4 | 5 | 6 | 7 |
| Tensile | 6.47 | 6.98 | 6.41 | 6.15 | 6.34 | 5.42 | 5.73 | 5.11 | 5.29 | 4.17 | 4.56 | 3.75 |
| Strength | | | | | | | | | | | | |
| (MPa) | | | | | | | | | | | | |

### Experimental Example 2: Evaluation of Lifetime Characteristic of Battery

### (1) Manufacture of Lithium Secondary Battery

The positive electrodes prepared in Examples 1 to 5 and Comparative Examples 1 to 7 were used, lithium metal was used as a counter electrode, and an electrolyte solution containing 1M LiPF₆ in a solvent containing EC:DMC:DEC (volume ratio of 1:2:1) was used, to manufacture a coin-type half-cell.

### (2) Evaluation of Capacity Retention Rate of Lithium Secondary Battery

After charging and discharging the coin-type half battery prepared above 100 times at 25° C. under the voltage range of 3 to 4.3 V and the current condition of 0.33 C-rate, the retention rate of the 100^{th} discharging capacity compared to the 1^{st} discharging capacity was calculated, and the results are shown in Table 3 below

TABLE 3

| | | | | | | Compar- | Compar- | Compar- | Compar- | Compar- | Compar- | Compar- |
|---|---|---|---|---|---|---|---|---|---|---|---|---|
| | | | | | | ative | ative | ative | ative | ative | ative | ative |
| | Example | Example | Example | Example | Example | Example | Example | Example | Example | Example | Example | Example |
| | 1 | 2 | 3 | 4 | 5 | 1 | 2 | 3 | 4 | 5 | 6 | 7 |
| Capacity | 96.8 | 96.1 | 95.8 | 94.7 | 95.5 | 94.3 | 93.6 | 93.2 | 92.4 | 92.1 | 91.7 | 88.9 |
| retention | | | | | | | | | | | | |
| rate | | | | | | | | | | | | |
| (100 cycle) | | | | | | | | | | | | |

Although the present disclosure has been described with reference to the above-mentioned preferred examples, various modifications and variations can be made without departing from the spirit and scope of the invention. Accordingly, the appended claims will cover such modifications and variations as long as they fall within the gist of the present disclosure.

### DESCRIPTION OF REFERENCE NUMERALS

10: First screw kneader
10′: Second screw kneader
13, 13′: Shaft
15, 15′: Blade
20: Driving mechanism body
21: First rotation driving mechanism
21′: Second rotation driving mechanism
23: Revolution driving mechanism
30: Mixing tank

1. A high shear mixing device comprising:
a first screw kneader and a second screw kneader;
a first rotation driving mechanism configured to rotate the first screw kneader and a second rotation driving mechanism configured to rotate the second screw kneader;
a revolution driving mechanism including the first rotation driving mechanism and the second rotation driving mechanism rotatably installed therein;
a driving mechanism body including the revolution driving mechanism is installed therein; and
a mixing tank,
wherein each of the first screw kneader and the second screw kneader comprises a shaft having one end respectively connected to the first rotation driving mechanism and the second rotation driving mechanism; and three or more blades having one end fixed to the shaft and having a helically curved body along the longitudinal direction of the shaft, and
wherein the first and second screw kneaders rotate in opposite directions with their blades overlapping each other.

2. The high shear mixing device according to claim 1, wherein the first and second screw kneaders rotate by the first and second rotation driving mechanisms and revolve by the revolution driving mechanism at the same time.

3. The high shear mixing device according to claim 2, wherein all of the blades provided in the first screw kneader and the second screw kneader are open-type blades comprising a through hole formed in a center portion except an outer periphery of a surface in a rotation direction.

4. The high shear mixing device according to claim 2, wherein all of the blades provided in the first screw kneader and the second screw kneader are closed-type blades of which a surface in a rotation direction is closed without a through hole.

5. The high shear mixing device according to claim 2, wherein all of the blades provided in the first screw kneader are open-type blades comprising a through hole formed in a center portion except an outer periphery of a surface in a rotation direction, and all of the blades provided in the second screw kneader are closed-type blades of which a surface in a rotation direction is closed without a through hole.

6. The high shear mixing device according to claim 2, wherein each of the first screw kneader and the second screw kneader has three blades.

7. The high shear mixing device according to claim 6, wherein one of the three blades provided in each of the first screw kneader and the second screw kneader is an open-type blade comprising a through hole formed in a center portion except an outer periphery of a surface in a rotation direction, and the other two blades are closed-type blades of which a surface in a rotation direction is closed without a through hole.

8. The high shear mixing device according to claim 3, wherein each of the through holes formed in the blades is formed to extend to an outer peripheral surface of the shaft.

9. The high shear mixing device according to claim 3, wherein the shaft between the through holes is removed such that all of the through holes formed in the blades communicate with each other.

10. The high shear mixing device according to claim 1, wherein distal ends in a rotation direction of the blades provided in one of the first screw kneader and the second screw kneader rotate, while maintaining a separation distance of 1 mm to 10 mm from the other screw kneader.

11. The high shear mixing device according to claim 1, wherein the high shear mixing device is used for micro-fiberization of a fiberizable polymer by high shear mixing a mixture for preparing a dry electrode containing the fiberizable polymer as a binder.

12. The high shear mixing device according to claim 5, wherein each of the through holes formed in the blades is formed to extend to an outer peripheral surface of the shaft.

13. The high shear mixing device according to claim 7, wherein each of the through holes formed in the blades is formed to extend to an outer peripheral surface of the shaft.

14. The high shear mixing device according to claim 5, wherein, in the screw kneader comprising the open-type blades, the shaft between the through holes is removed such that all of the through holes formed in the blades communicate with each other.
